(19) United States
(12) Patent Application Publication
(10) Pub. No.: US 2006/0227125 A1
(43) Pub. Date: Oct. 12, 2006

(54) Dynamic backlight control

(75) Inventors: Hong W. Wong, Portland, OR (US); Wah Yiu Kwong, Beaverton, OR (US)

Correspondence Address: INTEL CORPORATION, P.O. BOX 5326, SANTA CLARA, CA, 95056-5326, US

(73) Assignee: Intel Corporation

(21) Appl. No.: 11/093,402

(22) Filed: Mar. 29, 2005

(51) Int. Cl. G09G 5/00

(52) U.S. Cl. 345/211

(57) ABSTRACT

Display power consumption may be reduced by identifying an interested area and one or more non-interested areas of an application executing within an active window and by reducing brightness of pixels associated with the non-interested areas.

### FIELD OF THE INVENTION

The present invention relates generally to field of power management. More specifically, the present invention relates to methods and apparatus for controlling power consumption of displays.

### BACKGROUND

As more functionality is integrated into modern computer systems, the need to reduce power consumption becomes increasingly important, especially when the computer systems are mobile systems that operate on battery power. Users of mobile systems continuously expect longer battery life.

Mobile system designers try to address the need for longer battery life by implementing power management solutions that include reducing processor and chipset clock speeds, disabling unused components, and reducing power required by displays. Typically, displays used with today's computer systems are liquid crystal displays (LCDs) of transmissive type. Transmissive LCDs require a light source to light the pixels. The light from the light source is sometimes referred to as a backlight as it is located in the back of the LCD. Power consumption of the LCD increases with the brightness of the backlight. In some computer systems, the backlight power consumption may be at approximately 4 Watts and may soar as high as 6 Watts when at its maximum luminance. There are many on-going efforts aimed at reducing the power consumption associated with the display.

### BRIEF DESCRIPTION OF THE DRAWINGS

The present invention is illustrated by way of example, and not limitation, in the figures of the accompanying drawings in which like references indicate similar elements and in which:

FIG. 1 is a block diagram illustrating an example of a computer system that may be used, in accordance with an embodiment of the invention.

FIG. 2 illustrates an example of a display with a desktop having active and inactive windows, in accordance with one embodiment.

FIG. 3 illustrates an example of a display with a desktop having an active window and no inactive window, in accordance with one embodiment.

FIG. 4A illustrates an example of an active window that has been enlarged, in accordance with one embodiment.

FIG. 4B illustrates an example of an active window with an application having multiple identifiable areas, in accordance with one embodiment.

FIG. 5 illustrates an example of an active window having an interested area, in accordance with one embodiment.

FIG. 6 illustrates another example of an active window having an interested area, in accordance with one embodiment

FIG. 7 is a flow diagram illustrating an example of a process used to reduce display power consumption associated with an active window, in accordance with one embodiment.

### DETAILED DESCRIPTION

For one embodiment, methods to reduce display power consumption of a computer system are disclosed. By identifying an interested area associated with an application executing within an active window, power consumption of areas other than the interested area may be reduced.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

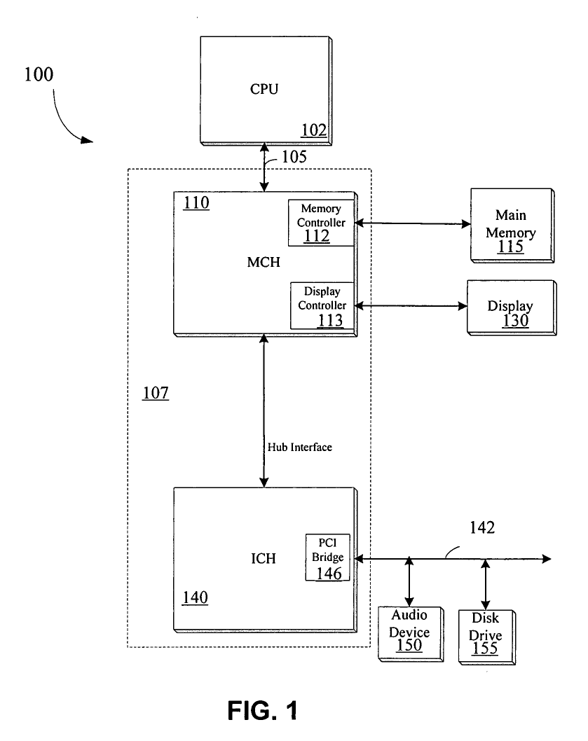

FIG. 1 is a block diagram illustrating an example of a computer system that may be used, in accordance with an embodiment of the invention. Computer system 100 may include a central processing unit (CPU) 102 and may receive its power from an electrical outlet or a battery. The CPU 102 may be coupled to a bus 105. The CPU 102 may be a processor manufactured by, for example, Intel Corporation of Santa Clara, Calif. Chipset 107 may be coupled to the bus 105. The chipset 107 may include a memory control hub (MCH) 110. The MCH 110 may include a memory controller 112 that is coupled to system memory 115 (e.g., random access memory (RAM), read-only memory (ROM), etc.). The system memory 115 may store data and sequences of instructions that are executed by the CPU 102 or any other processing devices included in the computer system 100. The chipset 107 may also include an input/output control hub (ICH) 140. The ICH 140 is coupled with the MCH 110 via a hub interface. The ICH 140 provides an interface to input/output (I/O) devices within the computer system 100. The ICH 140 may be coupled to a peripheral bus (e.g., Peripheral Component Interconnect (PCI) bus). Thus, the ICH 140 may include a PCI bridge 146 that provides an interface to a PCI bus 142. The PCI bridge 146 may provide a data path between the CPU 102 and peripheral devices. An audio device 150 and a disk drive 155 may be connected to the PCI bus 142. Although not shown, other devices (e.g., keyboard, mouse, etc.) may also be connected to the PCI bus 142.

Display

The MCH 110 may include a graphics interface 113. Display 130 may be coupled to the graphics interface 113. The display 130 may be implemented as a LCD, an organic light-emitting diode (OLED) display, or any other types of display. For one embodiment, the display 130 may be implemented using multiple backlights (not shown). The backlights may be fluorescent tubes. The backlights may be arranged in different pattern and may be associated with backlight control logic which controls the brightness of the backlights. When the display 130 is a LCD, the brightness of the backlights may affect the brightness of the pixels of the display 130 and therefore the brightness of the image or information being displayed on the display 130. For one embodiment, the backlight control logic may be able to turn on, turn off, or adjust brightness of some or all of the backlights. When the display 130 is an OLED display, there may be no backlight, and the brightness of each of the pixels on the display 130 may be individually controlled.

Windows User Interface

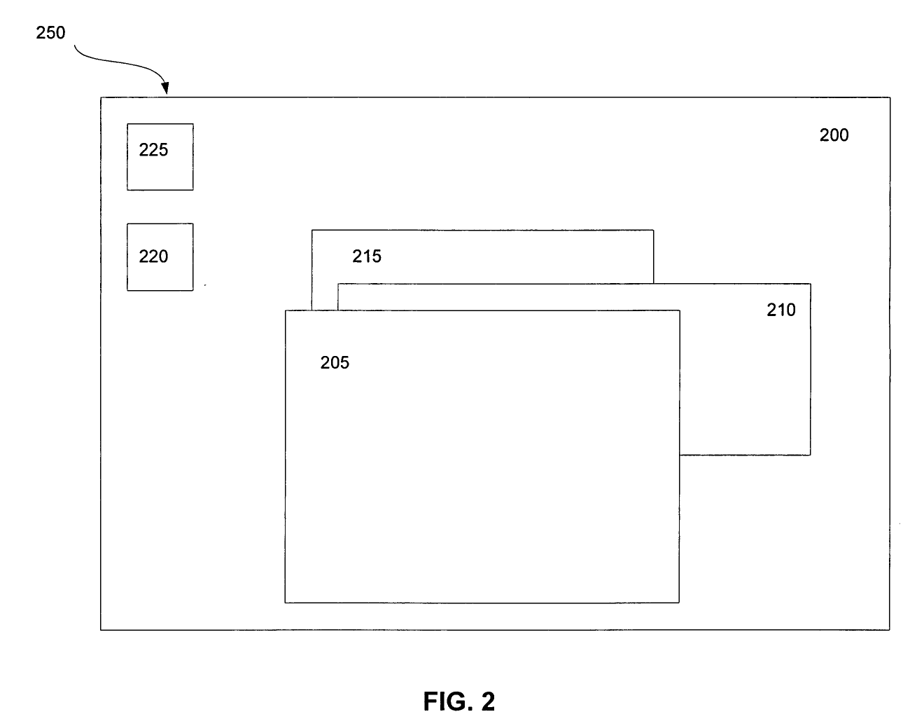

FIG. 2 illustrates an example of a display with a desktop having active and inactive windows, in accordance with one embodiment. For one embodiment, the computer system 100 may be configured to operate with a window-based operating system (OS) such as, for example, Microsoft Windows XP manufactured by Microsoft Corporation of Redmond, Wash. Display screen 250 may display a desktop 200 having multiple windows 205, 210 and 215. The desktop 200 may include icons relating to applications, folders, etc. such as, for example, icons 220 and 225. Typically, light from a backlight (not shown) may be distributed uniformly across the display screen 250. The brightness of the backlight may remain the same even though a user of the computer system 100 may not be interested in viewing certain areas of the display screen 250. For example, the window 205 may be selected by a user, and therefore it is in the foreground. It may be likely that the user is more interested in the information displayed in the window 205 than information displayed in the windows 210 and 215. When there is only one backlight, it is not possible to selectively control the distribution of light from the backlight. As a result, the pixels associated with the windows 205, 210 and 215 may be equally illuminated.

Dimming Inactive and Active Windows

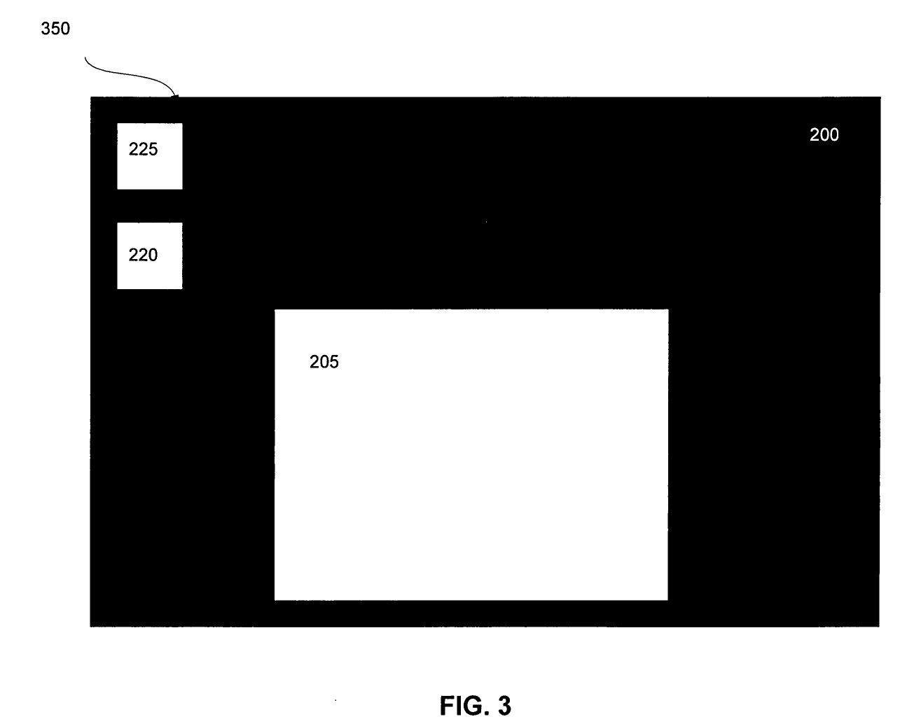

FIG. 3 illustrates an example of a display with a desktop having an active window and no inactive window, in accordance with one embodiment. Pixels on the display screen 350 may be associated with multiple backlights, or their illumination may be individually controlled. The display screen 350 may include the desktop 200 and similar information as the display screen 250 illustrated in FIG. 2, except for the difference that only the active window 205 is visible. The inactive windows 210 and 215 may not be visible because the pixels associated with these inactive windows are not illuminated. For one embodiment, the brightness of the inactive windows 210, 215 may be dimmed or may be reduced to zero. For another embodiment, the brightness of the active window 205 may be dimmed from a normal brightness level to a lower level while maintaining some degrees of visibility. The brightness may be changed by dimming the backlights that would illuminate the pixels associated with the inactive windows. The brightness may also be changed by controlling the illumination of the pixels when they are self-illuminated such as, for example, in OLED displays.

For another embodiment, the brightness of the active window 205 may be dimmed based on ambient light of the area in front of the computer system 100. An ambient light sensor may be used to provide feedback to the display control logic to control the brightness of the active window 205. Any ambient light sensing technique may be used. Although FIG. 3 illustrates the icons 220 and 225 as visible, they may also be made less visible by dimming associated pixels to further reduce display power consumption.

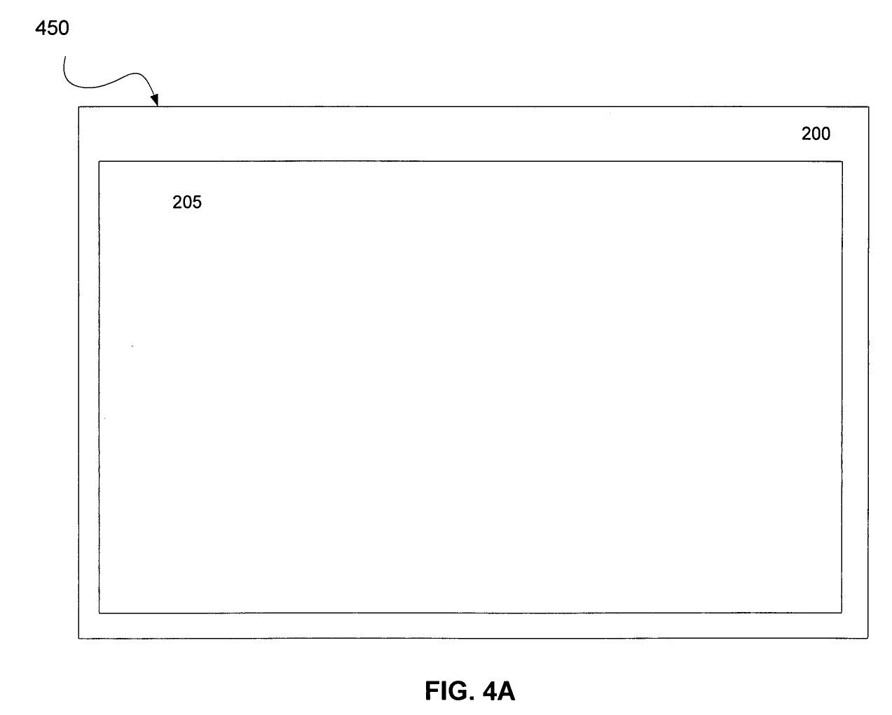

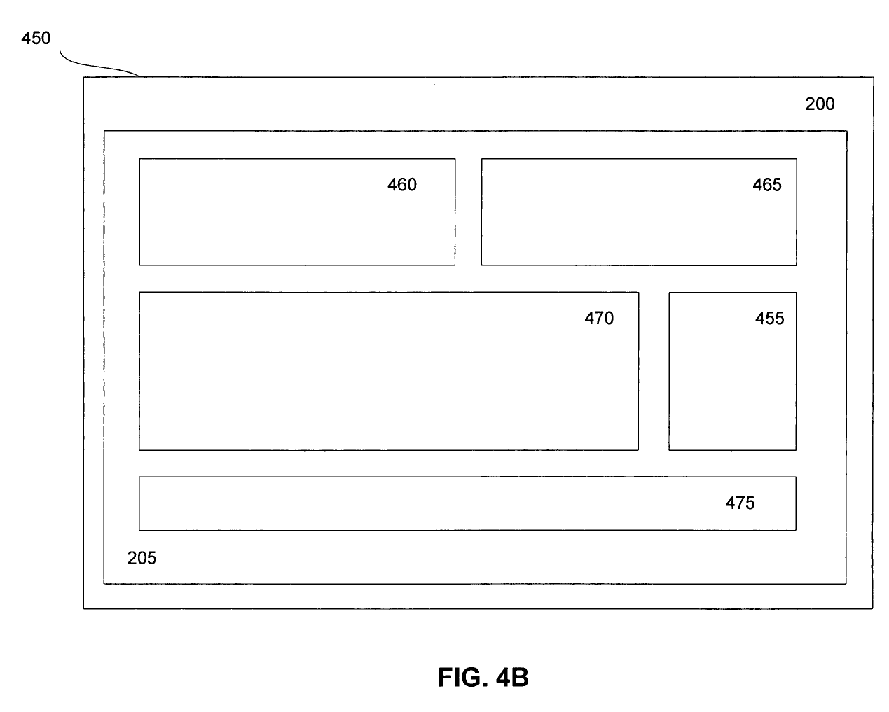

FIG. 4A illustrates an example of an active window that has been enlarged, in accordance with one embodiment. Display screen 450 may include the desktop 200 and similar information as the display screen 250 illustrated in FIG. 2. It may be noted that when the active window 205 is enlarged, the non-active windows 210-215 and the icons 220-225 may not be visible. In this situation, reducing the display power consumption by dimming the pixels associated with the non-active windows 210-25 and the icons 220-225 may not be possible because they are not visible.

Application-Specific Identifiable Areas

FIG. 4B illustrates an example of an active window with an application having multiple identifiable areas, in accordance with one embodiment. An application executing in the active window 205 on the display screen 450 may include multiple identifiable areas, any one of which may be selected as an interested area. In this example, the application executing in the active window 205 may include identifiable areas 460-475. An identifiable area may be an area that includes a set of related information. For example, an identifiable area may be a paragraph within a Microsoft Word document, a section of a Microsoft Power Point slide, etc. Microsoft Word and Microsoft Power Point are products of the Microsoft Corporation of Redmond, Wash.

For one embodiment, the location of the identifiable areas may be provided by the application executing in the active window. For example, the application may communicate with the display control logic the boundaries of the identifiable areas as displayed within an active window at a particular time.

The size of the identifiable areas may be different from one another, and the number of identifiable areas associated with an application may be different at different time, depending on the information being displayed in the active window 205. For example, the identifiable areas 460 and 465 may include texts in a left column and in a right column of a word processing document. The identifiable area 455 may include an image of the word processing document, etc. In a normal operation, a user may not recognize the identifiable areas 460-475 or their boundaries. This may be because the pixels associated with these identifiable areas 460-475 (and with the active window 205) are all illuminated.

Dimming Identifiable Areas

For one embodiment, an identifiable area may be an interested area or a non-interested area. The interested area may include information being read by a user, or it may include information being entered or updated by the user. Different techniques may be used to identify the interested area. For example, the interested area may be identified based on the position of a cursor, mouse pointer, where the user is focusing at, voice commands, etc. In the current example, the identifiable area 470 is an interested area.

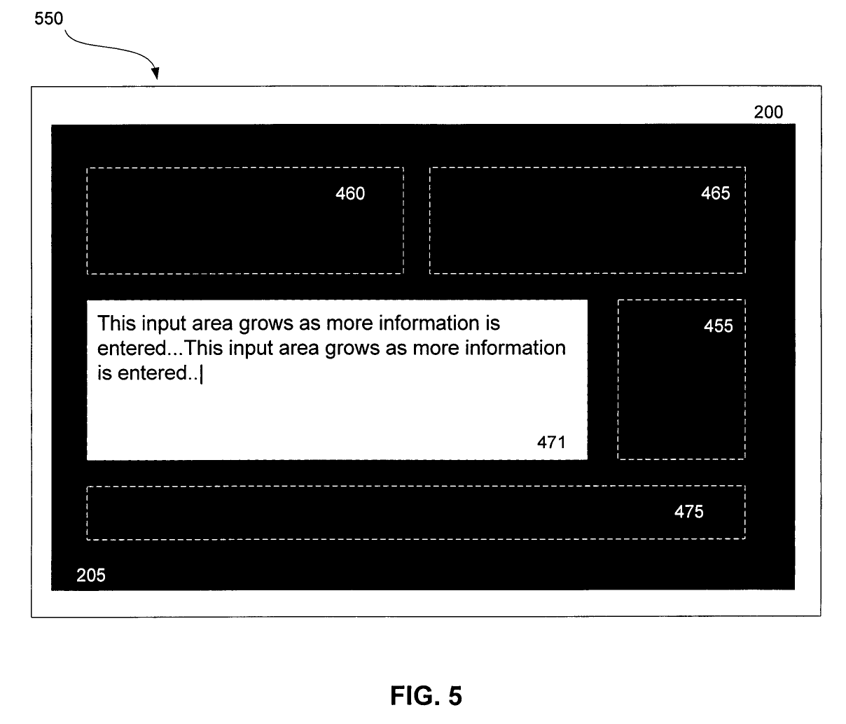

FIG. 5 illustrates an example of an active window having an interested area, in accordance with one embodiment. Display screen 550 may include similar information as the display screen 450 illustrated in FIG. 4B. In this example, the identifiable areas 455, 460, 465 and 475 are non-interested areas, and the identifiable area 471 is an interested area. For one embodiment, the brightness of a non-interested area may be dimmed or reduced to zero. For another embodiment, the brightness of all areas within an active window may be dimmed or reduced to zero, except for the interested area. The identifiable area 471 may be used as an input area to enter or update information. By dimming the non-interested areas, display power consumption associated with an active window may be further reduced. For one embodiment, the brightness of the non-interested area may be changed by powering off one or more backlights that are used to illuminate the pixels associated with the non-interested areas. For another embodiment, the brightness may be changed by controlling the emission of light of the pixels (e.g., in an OLED display).

Although the example illustrates an enlarged active window, the power reduction technique described above may also be used with a smaller-sized active window. In addition, although the identifiable area 471 is described as an input area to enter or to update information, the power reduction technique described above may also be used when the identifiable area 471 is used as a read area (e.g., when the user is only viewing the document).

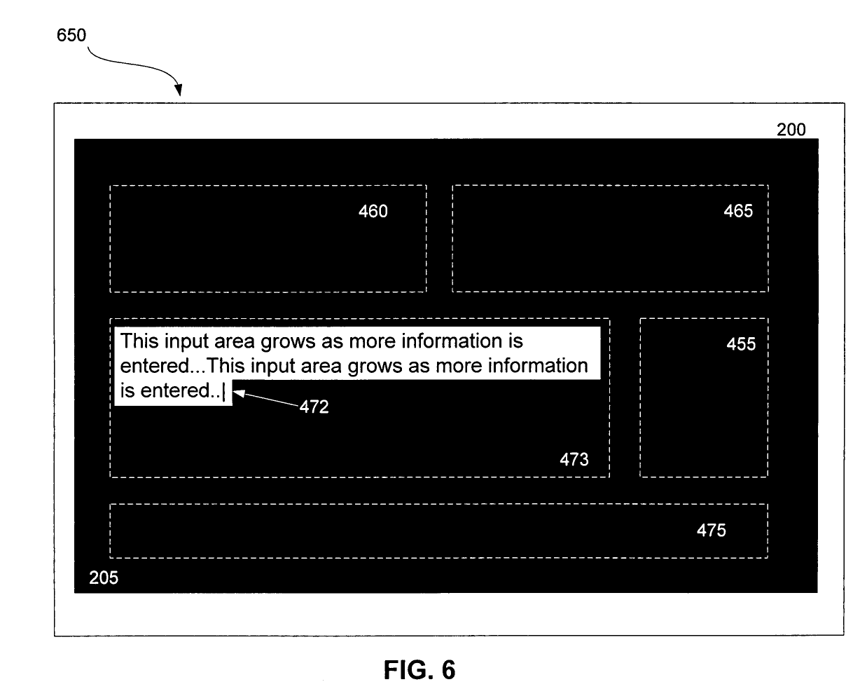

It may be noted that the identifiable area 471 may not be fully populated with information. As illustrated in FIG. 5, the bottom half of the identifiable area 471 is blank. FIG. 6 illustrates another example of an active window having an interested area, in accordance with one embodiment. The window 205 in FIG. 6 may be the same as the window 205 in FIG. 5. In this example, the identifiable area 473 is an interested area.

For one embodiment, a subset of the pixels associated with the identifiable area 473 may be illuminated while the rest of the pixels may not. This is illustrated in the identifiable area 473 with only a top portion of the identifiable area 473 illuminated. For another embodiment, more pixels of the identifiable area 473 may be illuminated as more information is entered into the identifiable area 473. For example, when the user enter a new character, and the cursor 472 moves forward to a next position, the pixels associated with the new character may be illuminated. Similarly, each time a character is deleted from the identifiable area 473, fewer pixels in the identifiable area 473 may be illuminated.

For one embodiment, the number of pixels that may be illuminated in the identifiable area 473 may be limited and may be less than the total number of pixels associated with the identifiable area 473. For example, the limitation may be that only two lines of text in the identifiable area 473 may be illuminated at a time.

Selecting Identifiable Area—Process

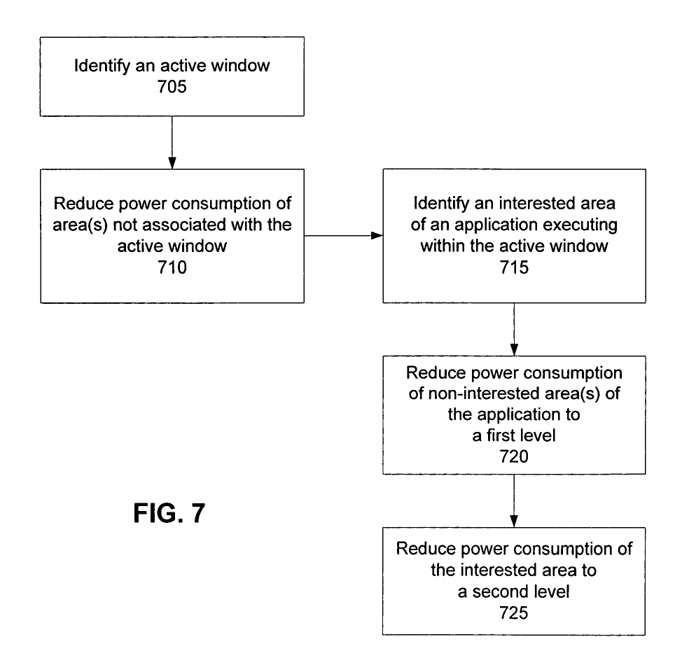

FIG. 7 is a flow diagram illustrating an example of a process used to reduce display power consumption associated with an active window, in accordance with one embodiment. A user using a computer system may open a new window, in which case the new window may be displayed in the foreground. Alternatively, the user may select a window that is already open, in which case the open window is also brought to the foreground. In either situation, a signal may be generated to indicate that a window is selected and is an active window.

There may be one active window and multiple non-active windows, and there may be some windows overlapping one another. At block 705, an active window is identified. At block 710, the display power consumption of the areas not associated with the active window is reduced. This may include, for example, dimming the pixels associated with the non-active window(s).

At block 715, an interested area of an application executing within the active window is identified. This identification may be based on a current location of the cursor, the mouse pointer, provided by the application itself, etc. At block 720, the power consumption of the non-interested areas is reduced. This may include reducing to a lower level or down to zero. At block 725, the power consumption of the interested area may also be reduced to a level that still enables the information in the interested area be visible.

Although the present invention has been described with reference to specific exemplary embodiments, it will be evident that various modifications and changes may be made to these embodiments without departing from the broader spirit and scope of the invention as set forth in the claims. For example, the techniques described may also be applied to reduce power consumption associated with a full screen application rather than limited to an application within an active window. Accordingly, the specification and drawings are to be regarded in an illustrative rather than a restrictive sense.

What is claimed is:

1. A method, comprising:
identifying an interested area of an application executing within an active window being displayed on a display of a computer system; and
reducing power consumption associated with at least one non-interested area of the application within the active window.

2. The method of claim 1, wherein reducing the power consumption comprises not illuminating pixels associated with the non-interested area of the application within the active window.

3. The method of claim 2, wherein not illuminating the pixels comprises turning off one or more backlights.

4. The method of claim 2, wherein not illuminating the pixels comprises reducing the emission of light by the pixels.

5. The method of claim 2, further comprising reducing power consumption associated with the interested area within the active window based on ambient light.

6. The method of claim 2, further comprising reducing power consumption associated with the interested area based on whether the interested area is being used for reading or for entering information.

7. A system comprising:
a processor;
a chipset coupled to the processor;
a display coupled to the chipset; and
a display logic coupled to the display, wherein the display logic is to reduce brightness of pixels associated with at least one non-interested area of an application executing within an active window.

8. The system of claim 7, wherein the display includes multiple backlights and wherein reducing the brightness of the pixels comprises reducing the brightness of at least one backlight.

9. The system of claim 7, wherein reducing the brightness of the pixels comprises reducing the illumination of the pixels.

10. The system of claim 9, wherein the display is an organic light-emitting diode (OLED) display.

11. The system of claim 7, wherein the display logic is further to reduce brightness of at least one backlight associated with at least one non-active window.

12. The system of claim 11, wherein the display logic is further to reduce brightness of pixels associated with the interested area based on ambient light.

13. The system of claim 11, wherein the display logic is further to reduce brightness of pixels associated with the interested area based on how the interested area is being used.

14. An apparatus, comprising:
logic to identify at least one non-interested area of an application executing within an active window and to reduce brightness of pixels associated with the non-interested area.

15. The apparatus of claim 14, further comprising:
logic to identify at least one non-active window and to reduce brightness of pixels associated with the non-active window.

16. The apparatus of claim 15, wherein the logic to reduce the brightness of the pixels associated with the non-interested area and with the non-active window comprises logic to reduce brightness of at least one backlight.

17. The apparatus of claim 15, wherein the logic to reduce the brightness of the pixels associated with the non-interested area and with the non-active window comprises logic to control illumination of the pixels.

18. An article comprising a machine-accessible medium having one or more associated instructions, wherein the instructions, if executed, results in a machine performing:
identifying an interested area of an application executing within an active window; and
reducing display power consumption of at least one area of the application outside of the interested area.

19. The article of claim 18, wherein reducing the display power consumption comprises reducing brightness of one or more backlights or reducing illumination of pixels.

20. The article of claim 18, further comprising reducing display power consumption of the interested area when the interested area is partially occupied with information.
